(19) United States
(12) Patent Application Publication
(10) Pub. No.: US 2005/0264044 A1
(43) Pub. Date: Dec. 1, 2005

(54) Furniture piece

(76) Inventor: Steve Lee, Park Ridge, IL (US)

Correspondence Address: Pauley Petersen & Erickson, Suite 365, 2800 West Higgins Road, Hoffman Estates, IL, 60195, US

(21) Appl. No.: 11/156,413

(22) Filed: Jun. 20, 2005

Related U.S. Application Data
(63) Continuation-in-part of application No. 10/744,940, filed on Dec. 23, 2003.

(51) Int. Cl. A47C 1/02; A61G 15/00

(52) U.S. Cl. 297/85

(57) ABSTRACT

A furniture piece includes a base and a member pivotally connected to the base. An attachment component is positionable or movable between an engaged position locking the member to the base, and a disengaged position allowing the member to move. The base may form a compartment which may contain at least one pivotally movable member of the furniture piece. The furniture piece may further one or more vibrators and/or speakers operably connectable to entertainment media.

### BACKGROUND OF THE INVENTION

1. Field of the Invention

This invention relates to a furniture piece that has a vibrator capable of providing tactile sensation and/or a transducer producing sounds incorporated within the furniture piece.

2. Description of Related Art

Conventional furniture pieces are typically built on a rigid frame. Relatively large boxes or packaging are required in order to ship and/or store the furniture pieces, thereby limiting the number of pieces that can be shipped to a location and/or stored at the location. There is an apparent need for a furniture piece that can be folded to make more efficient and to simplify shipping and/or storing of the furniture piece.

Further, with the increasing popularity of entertainment media such as computer-related video games and other amusement devices, there has arisen a desire for furniture pieces which provide stimulation to the occupant of the furniture piece based upon signals derived from an entertainment medium.

### SUMMARY OF THE INVENTION

It is one object of this invention to provide a furniture piece that may be easily shipped and/or stored.

Another object of the invention is to provide a furniture piece which includes a base and at least one of a seat portion or a backrest pivotally connected to the base. Each of the seat portion or the backrest can be pivotally movable with respect to the base between an upright or first position and an attached or second position. An attachment component can be positionable or movable between an engaged position, which locks or secures the seat portion or the backrest in the engaged position, and a disengaged position, which allows a user to move the seat portion or the backrest with respect to the base. Desirably, the seat portion may be pivotally movable with respect to the base between an open position and a closed position to expose or to close a compartment formed within or by the base.

It is still another object of this invention to provide a furniture piece with a vibrator or speakers, or both, attached within the furniture piece and capable of providing auditory and/or tactile sensation to a user of the furniture piece with the vibrator and speakers being operably connectable to an entertainment medium so as to be responsive to a signal produced from the entertainment medium.

Other objects and advantages of this invention will be apparent to those skilled in the art, in view of the following detailed description taken in conjunction with the appended claims and drawings.

### BRIEF DESCRIPTION OF THE DRAWINGS

The drawings show a furniture piece, according to preferred embodiments of this invention, wherein:

FIG. 1 is a back perspective view of a furniture piece according to one preferred embodiment of this invention;

FIG. 2 is a front perspective view of a furniture piece including a seat portion in an open position, according to one preferred embodiment of this invention;

FIG. 3 is a side view of a furniture piece including a backrest positioned with respect to a base in a folded position, according to one preferred embodiment of this invention;

FIG. 4 is a side view of a furniture piece including a backrest positioned with respect to a base in a folded position, according to an alternate preferred embodiment of this invention;

FIG. 5 is a side perspective view of a furniture piece in cube form, according to an alternate preferred embodiment of this invention;

FIG. 6 is a front perspective view of a furniture piece in cube form, showing the pivotable seat portion, according to an alternate preferred embodiment of this invention;

FIG. 7 is a side perspective view of a furniture piece in cube form, showing attachment of the furniture piece to an entertainment media player, according to an alternate preferred embodiment of this invention;

FIG. 8 is a corner perspective view of a furniture piece in cube form, having a plurality of speakers, according to an alternate preferred embodiment of this invention;

FIG. 9 is a front perspective view of a furniture piece, according to one preferred embodiment of this invention;

FIG. 10 is a back perspective view of a furniture piece showing an attachment component positioned on a backrest of the furniture piece, according to one preferred embodiment of this invention;

FIG. 11 is a front view of a furniture piece, according to one preferred embodiment of this invention;

FIG. 12 is a front perspective view of a furniture piece including a seat portion in an open position, according to one preferred embodiment of this invention;

FIG. 13 is a side view of a furniture piece including a backrest positioned with respect to a base in a folded position, according to one preferred embodiment of this invention;

FIG. 14 is a side view of a furniture piece including a backrest positioned with respect to a base in a folded position, according to an alternate preferred embodiment of this invention;

FIG. 15 is a schematic diagram of a vibrator according to one preferred embodiment of this invention; and

FIG. 16 is a schematic front view of a control panel according to one preferred embodiment of this invention.

### DESCRIPTION OF PREFERRED EMBODIMENTS

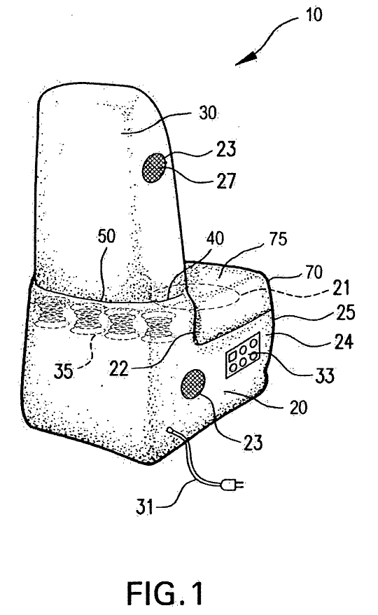

FIGS. 1-4 show a furniture piece 10 according to one preferred embodiment of this invention. As shown in FIGS. 1-4, the furniture piece 10 is formed as a chair. As known to those skilled in the art, the furniture piece 10 may form any other suitable furniture piece including, but not limited to, an ottoman, a couch or a sofa. Further, the furniture piece 10 may have at least one tactile transducer, e.g., a mechanical vibrator 21, or auditory transducers, collectively 23, or both, desirably contained within the furniture piece 10 so as to be protected during shipping and further provide a streamlined profile for the furniture piece 10. The auditory transducers, i.e., speakers, 23, are desirably protected but opened to the ambient environment for a clear reproduction of sound, such as by having a perforated grill, screen or cover 27. Means for powering the vibrator 21 or speakers 23 may be provided as indicated by an electric cord 31 leading to an amplifier, a transformer, a rectifier, or the like (not shown) as will be understood in the art. An input/output and control panel 33 provides means for operably connecting the furniture piece 10 to an entertainment medium (not shown) so as to receive and be responsive to a signal produced from the entertainment medium. The input/output (I/O) and control panel 33 may also provide a headphone jack, on/off switch, and volume and vibration controls such as potentiometers or the like, and such as described in more detail below.

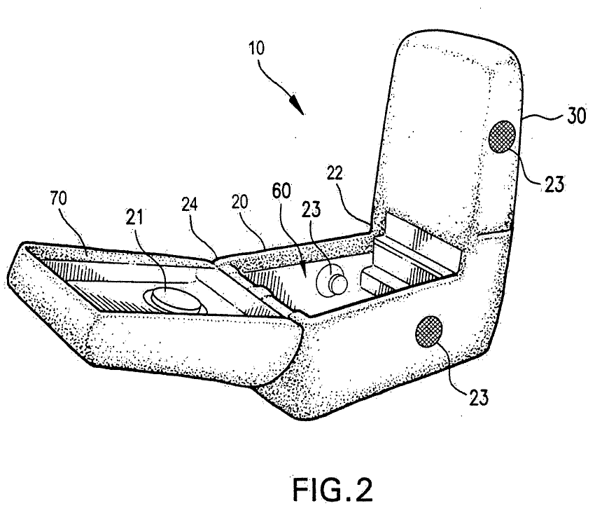

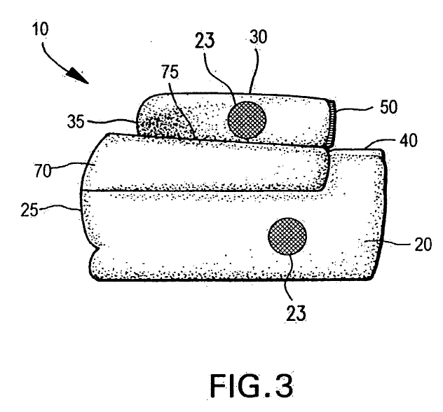

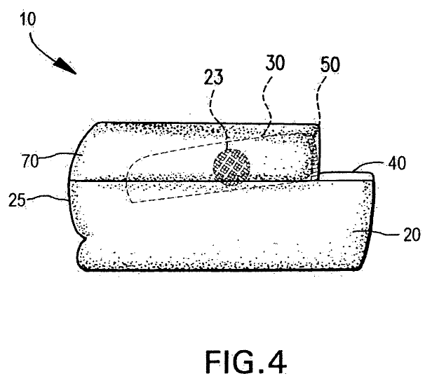

In some embodiments, the furniture piece 10 desirably comprises a base 20 and a backrest 30 pivotally connected to the base 20. The backrest 30 is pivotally connected to the base 20 at a first end portion 22 of the base 20 and pivotally movable with respect to the base 20 between an upright position, as shown in FIGS. 1-2, and a folded position, as shown in alternative FIGS. 3-4. The backrest 30 can be pivotally connected to the base 20 using any suitable mechanical connection that allows the backrest 30 to pivot or otherwise move with respect to the base 20, such as one or more hinges. In one preferred embodiment of this invention, the suitable mechanical connection limits the pivotal movement of backrest 30 in at least one direction, such as a backward direction with respect to base 20. A spring mechanism 35 may be incorporated into the furniture piece 10, such as in the base 20 adjacent the base-to-backrest abutment area to provide further comfort and resiliency to the furniture piece 10.

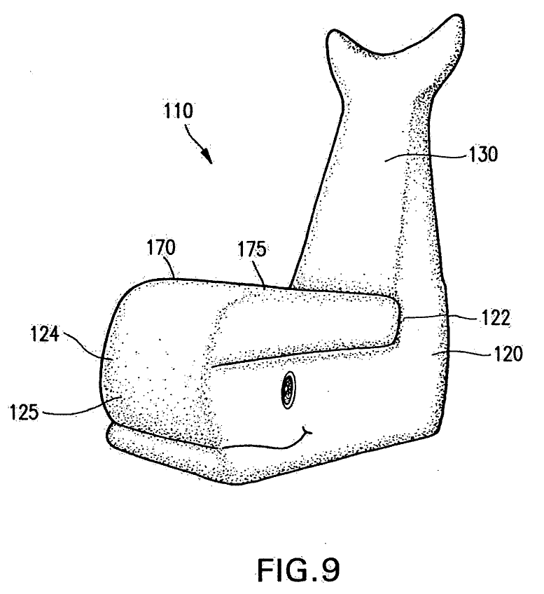

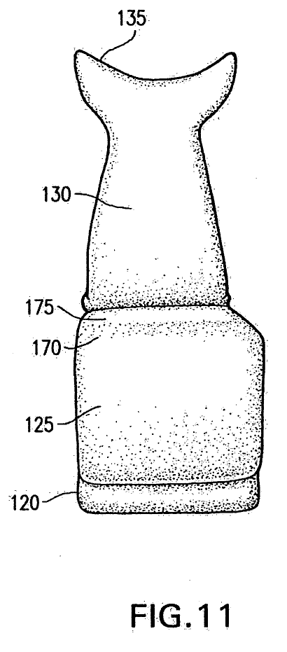

In one preferred embodiment of this invention, an attachment mechanism or component 40 is operably connected with respect to backrest 30, as also discussed below with respect to FIGS. 9-14. Attachment component 40 preferably comprises at least one zipper 50, as shown in FIG. 1, that is positionable or movable between a closed or engaged position and an open or disengaged position.

In the engaged position, the attachment component 40 locks or secures the backrest 30 in an upright position of attachment with respect to base 20. With the backrest 30 in the upright position, a user can sit on the furniture piece 10 and comfortably rest against the backrest 30. With the attachment component 40 in the disengaged position, the backrest 30 can be moved or pushed in a position of nonattachment towards the base 20, allowing the user to fold the backrest 30 to a folded position with respect to the base 20, as shown in FIGS. 3-4, for easy and efficient shipment and/or storage of the furniture piece 10.

As shown in FIG. 2, one embodiment of the furniture piece 10 preferably comprises a compartment 60 formed by or within the base 20. In one preferred embodiment of this invention, the furniture piece 10 further comprises the seat portion 70 pivotally connected to a second end portion 24 of the base 20 wherein the seat portion 70 has attached thereto the vibrator 21. The seat portion 70 covers at least a portion of the compartment 60, and the vibrator 21 is mounted to the surface of the seat portion 70 facing the compartment 60. In an alternate embodiment of this invention, the seat portion 70 may be integrated with, or fixedly attached or connected to, the base 20, as further discussed below. The compartment 60 may further contain a speaker 23 which might be a speaker of the subwoofer type whose sonic vibrations are enhanced by the cavity of the compartment 60. Suitable electrical connections (not shown) between the electrical and electronic components may be easily routed through the compartment 60. The compartment 60 may further provide storage for entertainment media, headphones, or the like (not shown).

The backrest 30 may contain at least a portion of one or more speakers 23 and is foldable with respect to the base 20 to allow for easy shipping and/or storage of the furniture piece 10. In one embodiment of this invention as shown in FIG. 3, the seat portion 70 is in the closed position with respect to the base 20, and with the backrest 30 in the folded position at least a portion of the backrest 30 contacts the seat portion 70, as further discussed below with respect to FIGS. 9-14.

As seen in FIG. 4, an alternate preferred embodiment of this invention provides in the folded position the backrest 30, the compartment 60 and/or the seat portion 70 designed, dimensioned and configured so that at least a portion of the backrest 30 is contained or positioned within the compartment 60. The zipper 50 or other attachment component 40 allows a portion of the furniture piece, in this case the backrest 30, to be positionable between a position of engagement with the compartment 60 and a position of disengagement with the compartment 60. In this embodiment the backrest 30 desirably is entirely contained within compartment 60, and seat portion 70 is positioned in the closed position with respect to the compartment 60 to cover the backrest 30 in the folded position. The backrest 30 may contain all of the speakers 23 of the furniture piece 10, which are thereby enclosed and protected against shipping damage and the like.

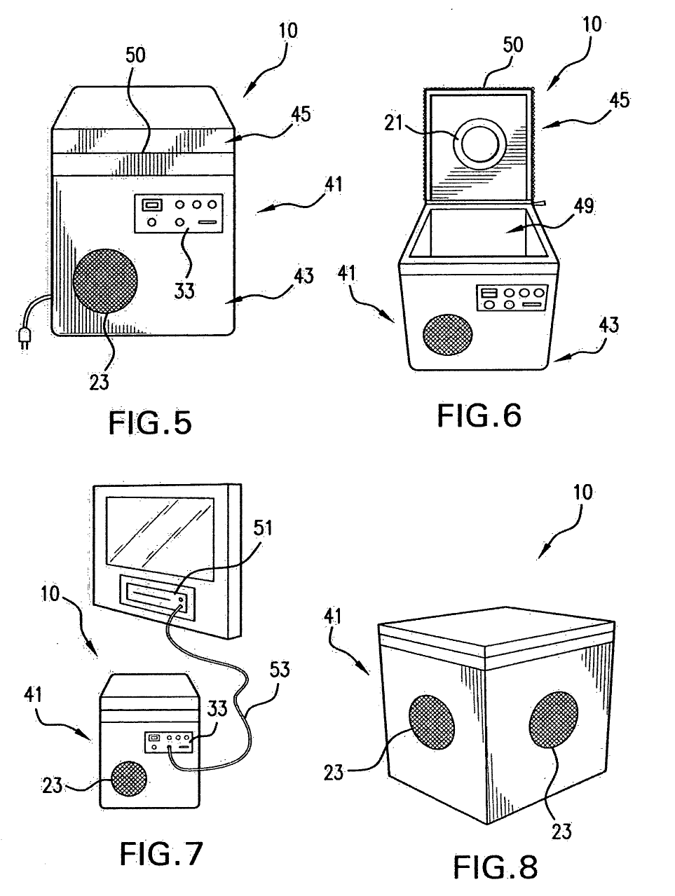

As seen in FIGS. 5-8, an alternative embodiment of the furniture piece 10 is based on a cube shape 41 having a base 43 and a seat portion 45. The base 43 may be hollow and form a compartment 49 as seen in FIG. 6. The seat portion 45 can be pivotally connected to the base 43, to make the seat portion 45 pivotally movable between an open position, or position of nonattachment, with the base 43 substantially exposing the compartment 49 as seen in FIG. 6, and a closed position, or position of attachment, with the base 43 substantially covering the compartment 49 as seen in FIGS. 5, 7 and 8. The seat portion 45 may be securely fastened to the base 43 by an attachment component such as a zipper 50 or such other fastening or securement means as are desired. The zipper 50 or other attachment component allows a portion of the furniture piece, in this case the seat portion 45, to be positionable between a position of engagement with the base 43 and a position of disengagement with the base 43.

The vibrator 21 (FIG. 6) is attached onto the seat portion 45 to be contained within the compartment 49 in the closed position, and thereby placed to be directly capable of providing tactile sensation to a user sitting on the furniture piece 10 when the vibrator 21 is operably connected to an entertainment medium player 51, such as through the I/O and control panel 33, so as to be responsive to a signal produced from the entertainment medium player 51, as seen in FIG. 7. Although shown as hard-wire connected by a cable 53 in FIG. 7, it will be appreciated that any means of transferring the signal to the furniture piece 10 may be realized. The compartment 49 may itself provide room for the entertainment media player 51 if desired.

As seen in FIGS. 5, 7 and 8, the furniture piece 10 may have one or more speakers 23 attached on its cube form 41, and in some cases the speakers 23 may desirably be placed within, or at least partially vented to, the compartment 49.

FIGS. 9-14 show a furniture piece 110 according to one preferred embodiment of this invention. As shown in FIG. 9, furniture piece 110 is formed as a chair. As known to those skilled in the art, furniture piece 110 may form any other suitable furniture piece including, but not limited to, a couch or a sofa. Further, furniture piece 110 may have any suitable or desirable shape, configuration and/or size. For example, furniture piece 110 may comprise a chair shaped as a whale, as shown in FIGS. 9-14, or furniture piece 110 may resemble any suitable or desirable animal or other character, in shape, configuration and/or size.

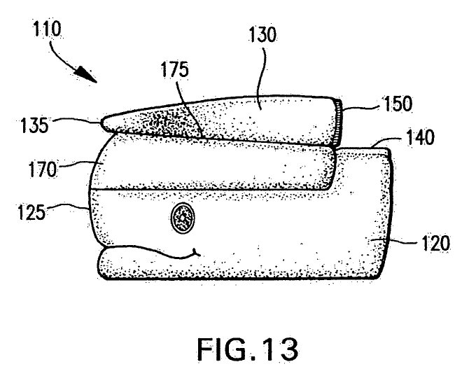

Preferably, furniture piece 110 comprises a base 120 and a backrest 130 pivotally connected to base 120. Backrest 130 is pivotally connected to base 120 at a first end portion 122 of base 120 and pivotally movable with respect to base 120 between an upright position, as shown in FIGS. 9-13 and a folded position, as shown in FIG. 13. Backrest 130 can be pivotally connected to base 120 using any suitable mechanical connection that allows backrest 130 to pivot or otherwise move with respect to base 120, such as one or more hinges. In one preferred embodiment of this invention, the suitable mechanical connection limits the pivotal movement of backrest 130 in at least one direction, such as a backward direction with respect to base 120.

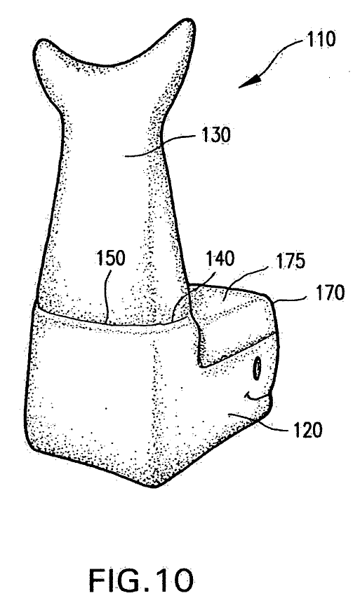

In one preferred embodiment of this invention, an attachment mechanism or component 140 is operatively connected with respect to backrest 130. Attachment component 140 is preferably attached or connected to backrest 130 using any suitable attachment or connection. For example, as shown in FIG. 10, attachment component 140 is sewn into backrest 130. Other suitable attachment or connection mechanisms, such as an adhesive attachment and/or a hook-and-loop attachment, may be used to attach or connect attachment component 140 with respect to backrest 130. Attachment component 140 preferably comprises at least one zipper 150, as shown in FIG. 10, that is positionable or movable between a closed or engaged position and an open or disengaged position. In the engaged position, attachment component 140 locks or secures backrest 130 in the upright position with respect to base 120. With backrest 130 in the upright position, a user can sit on furniture piece 110 and comfortably rest against backrest 130. With attachment component 140 in the disengaged position, backrest 130 can be moved or pushed towards base 120, allowing the user to fold backrest 130 to a folded position with respect to base 120, as shown in FIG. 13, for easy and efficient shipment and/or storage of furniture piece 110.

Referring to FIG. 10, in one preferred embodiment of this invention wherein attachment component 140 comprises zipper 150, the engaged position corresponds to zipper 150 being zipped or closed and the disengaged position corresponds to zipper 150 being unzipped or open. Other suitable attachment mechanisms or components can be used to position backrest 130 with respect to base 120, such as at least one snap, at least one button and/or at least one hook-and-loop fastener component.

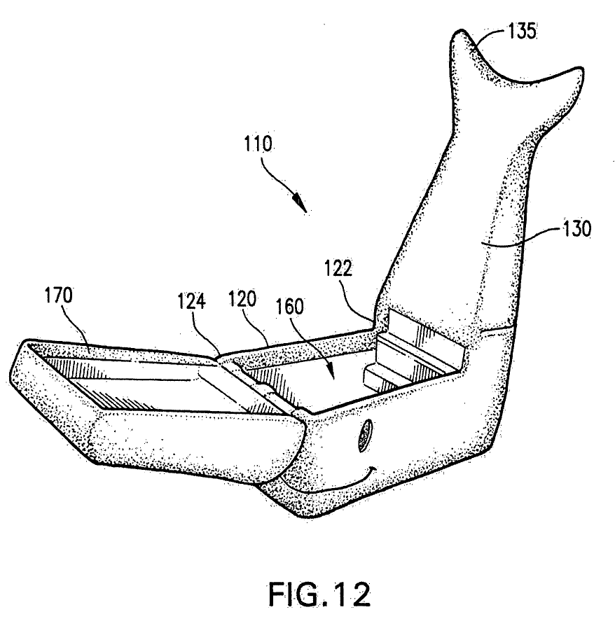

Desirably, furniture piece 110 may comprise a compartment 160 formed by or within base 120, as shown in FIG. 12. In one preferred embodiment of this invention, furniture piece 110 further comprises a seat portion 170 pivotally connected to a second end portion 124 of base 120 and positionable with respect to compartment 160 formed by base 120. Seat portion 170 can be pivotally connected to base 120 using any suitable mechanical connection that allows seat portion 170 to pivot or otherwise move with respect to base 120, such as one or more hinges. Seat portion 170 is pivotally movable with respect to base 120 between an open position, as shown in FIG. 12, and a closed position, as shown in FIGS. 9-11 and 13-14, wherein seat portion 170 covers at least a portion of compartment 160. In an alternate embodiment of this invention, seat portion 170 can be integrated with or fixedly attached or connected to base 120.

Backrest 130 is preferably foldable with respect to base 120 to allow for easy shipping and/or storage of furniture piece 110. In one preferred embodiment of, this invention as shown in FIG. 13, seat portion 170 is in the closed position with respect to base 120 and with backrest 130 in the folded position, at least a portion of backrest 130 contacts seat portion 170. For example, backrest 130 can be folded so that at least a portion of backrest 130 contacts a top or seating surface 175 of seat portion 170. In the folded position, preferably but not necessarily, a top 135 of backrest 130 is generally coterminous, aligned or flush with a front 125 of base 120. The term coterminous as used herein refers to a portion or component of the furniture piece having a common or corresponding boundary with at least one other portion or component of the furniture piece.

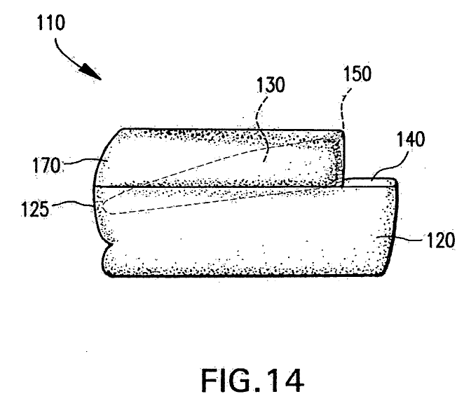

In an alternate preferred embodiment of this invention shown in FIG. 14, in the folded position, backrest 130, compartment 160 and/or seat portion 170 are designed, dimensioned and configured so that at least a portion of backrest 130 is contained or positioned within compartment 160. Preferably, in this embodiment backrest 130 is entirely contained within compartment 160 and seat portion 170 is positioned in the closed position with respect to compartment 160 to cover backrest 130 in the folded position.

Referring to FIGS. 9-14, furniture piece 110 can be folded to provide for easy shipping and/or storage. Backrest 130 is unlocked from the upright position by positioning or moving attachment component 140 from the engaged position to the disengaged position. For example, zipper 150, as shown in FIG. 10, is unzipped from the engaged position. With attachment component 140 in the disengaged position, the user can move or push backrest 130 towards the folded position and fold backrest 130 with respect to base 120, as shown in FIG. 13. Backrest 130 is folded to contact seating surface 175 of seat portion 170 so that top 135 of backrest 130 is generally coterminous, aligned or flush with front 125 of base 120. In an alternate preferred embodiment of this invention, backrest 130 is folded into and positioned within compartment 160, and seat portion 170 is closed by pivotally moving seat portion 170 with respect to base 120 from the open position, as shown in FIG. 12, to the closed position to cover backrest 130. In the folded position, furniture piece 110 can be placed in a suitable package for shipping and/or storage, such as a box or other suitable packaging, particularly in a volume-efficient manner that saves significant shipping costs.

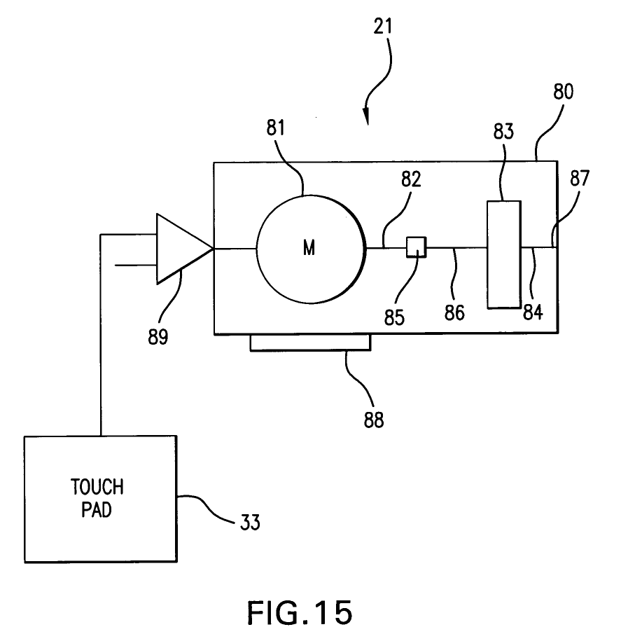

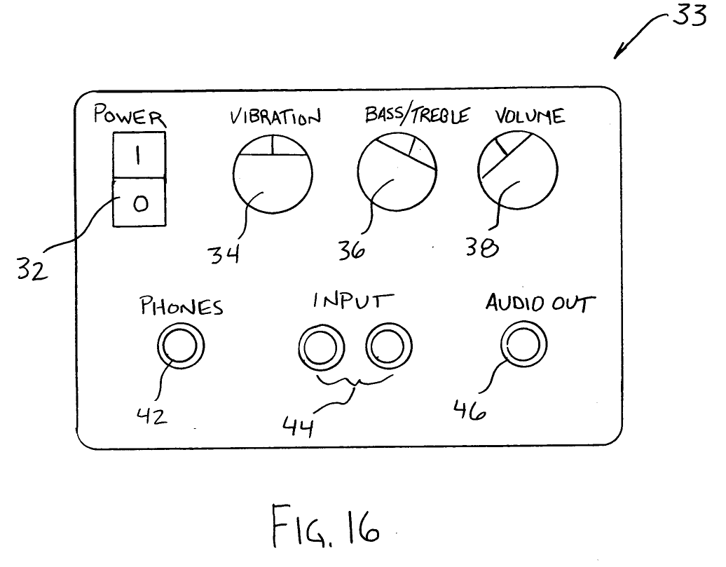

Referring to FIG. 15, there is shown a schematic of an exemplary embodiment of a vibrator 21 for use in the present invention, such as for use with the furniture pieces 10 shown in FIGS. 1-8. The vibrator 21 comprises at least an electric motor 81 with a motor shaft 82. The motor shaft 82 is coupled to an eccentric weight 83. A housing 80 desirably contains the motor 81, the motor shaft 82, and the eccentric weight 83. As shown, the eccentric weight 83 is mounted to a separate shaft 84 which is coupled to the motor shaft 82 by a mechanical coupling 85 at a first end 86 of the separate shaft 84. A second end 87 of the separate shaft 84 is coupled to the housing 80. A connector plate 88 is affixed to, or integral with, the housing 80 for mounting the vibrator 21, preferably in a direct coupling to a furniture piece (not shown). An amplifier 89 is connected to the motor 81 for control of vibration level. For example, as a sound volume of the entertainment media (not shown) increases, the power to the motor 81 may correspondingly increase, thereby increasing the rotational speed or torque of the motor 81 and the turning of the eccentric weight 83, thereby increasing the vibration. Control of the amplifier settings may be had through the I/O and control panel 33, in this case illustrated as a touch-pad.

FIG. 16 demonstrates one preferred embodiment of control panel 33. Control panel 33 may include one or more separate adjustment devices for vibration; for tone such as bass/treble; and/or for volume. A knob, toggle, button or similar adjustment device may be used to adjust the desired parameter. In addition, control panel 33 preferably includes power switch 32, headphone jack 42 and input jack(s) 44. Control panel 33 may further include audio out jack 46 for connecting one or more furniture pieces 10 and/or other audio/vibration devices in series.

According to a preferred embodiment of this invention, vibrator 21 and speakers 23 are separately connected to the respective adjustment device and thereby separately and independently controllable. As such, and as shown in FIG. 1, speaker 23 is positioned with respect to seat portion 70 and vibrator 21 is positioned with respect to seat portion 70. A control, such as control panel 33, for controlling a volume output of speaker 23 and a vibration output of vibrator 21 is connected with respect to the speaker 23 and the vibrator 21 so that a volume output is independent of a vibration output. According to a preferred embodiment of this invention, vibrator 21 and speaker 23 are operably connectable to an entertainment medium so as to be responsive to a signal produced from the entertainment medium.

As described, the control, such as control panel 33, includes volume control 34 for controlling the volume output of the speaker; a bass/treble control 36 for controlling the frequency or tonal output of the speaker; and a vibration control 38 for controlling the vibration output of the vibrator. According to a preferred embodiment of this invention, vibration control 34 produces a vibration output from vibrator 21 independent of the volume output of speaker 23. Likewise, according to a preferred embodiment of this invention, volume control 38 produces a volume output from speaker 23 independent of the vibration output of vibrator 21. As such, depending upon the desired application, a user can adjust volume control 38 down or off and vibration control 34 to a desired level resulting in vibration output from furniture piece 10 but no volume output. Conversely, the user can adjust vibration control 34 down or off and volume control 38 to a desired level and avoid any vibration output. As a result of the described embodiment of furniture piece 10 having both a vibrator 21 and a speaker 23, the resulting furniture piece 10 does not necessarily rely on speaker 23, i.e., a transducer or low frequency bass output, for vibration. This may have applicability if the user does not want vibrations during a period of music listening or if the user does not want appreciable speaker volume during video game play involving tactile response features.

As a result of the described configuration, furniture piece 10 may include one or more vibrators 21 and one or more speakers 23 that have independent control and output. The resulting furniture piece 10 is thereby entirely flexible to user selected volume, vibration and tone.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

1. A furniture piece comprising:
a base;
at least one of a vibrator and a speaker capable of providing sensation to a user of the furniture piece;
the at least one of a vibrator and a speaker operably connectable to an entertainment medium so as to be responsive to a signal produced from the entertainment medium; and
an attachment component fixing a member of the furniture piece into a position of engagement with the base from a position of nonengagement with the base.

2. The furniture piece of claim 1 wherein the member of the furniture piece is a seat portion.

3. The furniture piece of claim 1 wherein the member of the furniture piece is a backrest.

4. The furniture piece of claim 3 further comprising means for locking the backrest in an upright position.

5. The furniture piece of claim 1 wherein the furniture piece has a vibrator comprising a motor and an eccentric weight.

6. The furniture piece of claim 1 further comprising:
a control connected with respect to the speaker and the vibrator, the control for controlling a volume output of the speaker and a vibration output of the vibrator, the volume output independent of the vibration output.

7. A furniture piece comprising:
a base including a seat portion;
a backrest pivotally connected to the base, the backrest pivotally movable between an upright position and a folded position;
an attachment component positionable between an engaged position locking the backrest in the upright position and a disengaged position allowing the backrest to move towards the folded position;
at least one of a vibrator and a speaker capable of providing sensation to a user of the furniture piece;
the at least one of a vibrator and a speaker operably connectable to an entertainment medium so as to be responsive to a signal produced from the entertainment medium.

8. The furniture piece of claim 7 further comprising the base forming a compartment.

9. The furniture piece of claim 8 wherein, in the folded position, at least a portion of the backrest is contained within the compartment.

10. The furniture piece of claim 7 further comprising a speaker for producing vibrations.

11. The furniture piece of claim 10 wherein the speaker produces tactile and auditory vibrations.

12. The furniture piece of claim 7 further comprising a vibrator.

13. The furniture piece of claim 12 wherein the vibrator comprises a housing containing an electric motor operably connected to an eccentric weight.

14. The furniture piece of claim 13 wherein a speed of the electric motor is controlled in relation to the signal of the entertainment medium.

15. The furniture piece of claim 7 further comprising:
a control connected with respect to the speaker and the vibrator, the control for controlling a volume output of the speaker and a vibration output of the vibrator, the volume output independent of the vibration output.

16. A furniture piece comprising:
a base;
the base forming a compartment;
a seat portion pivotally connected to the base, the seat portion pivotally movable between an open position substantially exposing the compartment and a closed position substantially covering the compartment;
at least one of a vibrator and a speaker capable of providing sensation to a user of the furniture piece;
the at least one of a vibrator and a speaker operably connectable to an entertainment medium so as to be responsive to a signal produced from the entertainment medium; and
an attachment component allowing a member of the furniture piece to be positionable between a position of engagement with the base and a position of nonengagement with the base.

17. The furniture piece of claim 16 wherein both the vibrator and the speaker are attached within the compartment.

18. The furniture piece of claim 17 further comprising:
a control connected with respect to the speaker and the vibrator, the control for controlling a volume output of the speaker and a vibration output of the vibrator, the volume output independent of the vibration output.

19. The furniture piece of claim 16 wherein the member of the furniture piece is the seat portion.

20. The furniture piece of claim 16 wherein the member of the furniture piece is a backrest.

21. The furniture piece of claim 20 further comprising means for locking the backrest in an upright position.

22. The furniture piece of claim 21 wherein the means for locking is further constructed for allowing the backrest to be released from the upright position.

23. The furniture piece of claim 16 wherein the furniture piece includes a vibrator comprising a housing containing an electric motor operably connected to an eccentric weight and wherein a speed of the electric motor is controlled in relation to a signal from the entertainment medium.

24. A furniture piece comprising:
a seat portion;
a speaker positioned with respect to the seat portion;
a vibrator positioned with respect to the seat portion; and
a control for controlling a volume output of the speaker and a vibration output of the vibrator, the volume output independent of the vibration output.

25. The furniture piece of claim 24 wherein the vibrator and the speaker are operably connectable to an entertainment medium so as to be responsive to a signal produced from the entertainment medium.

26. The furniture piece of claim 25 wherein the control comprises:
a volume knob for controlling the volume output of the speaker;
a bass/treble knob for controlling the frequency output of the speaker; and
a vibration knob for controlling the vibration output of the vibrator independent of the volume output of the speaker.
